(19) United States
(12) Patent Application Publication
(10) Pub. No.: US 2010/0127620 A1
(43) Pub. Date: May 27, 2010

(54) PLASMA DISPLAY PANEL AND PRODUCTION METHOD THEREOF

(75) Inventors: Yasumasa Wada, Hyogo (JP); Seiji Nishitani, Kyoto (JP); Masaki Nishinaka, Osaka (JP); Hiroyuki Yonehara, Osaka (JP)

Correspondence Address: RATNERPRESTIA, P.O. BOX 980, VALLEY FORGE, PA, 19482, US

(73) Assignee: MATSUSHITA ELECTRIC INDUSTRIAL CO., LTD., Osaka (JP)

(21) Appl. No.: 11/815,923

(22) PCT Filed: Mar. 19, 2007
(86) PCT No.: PCT/JP2007/055534

§ 371 Date: Aug. 9, 2007

(30) Foreign Application Priority Data
Apr. 13, 2006 (JP) 2006-110638

(51) Int. Cl. H01J 17/49; H01J 9/26

(52) U.S. Cl. 313/582; 445/25

(57) ABSTRACT

A plasma display panel is provided with a front substrate (22); a rear substrate (23) arranged to face the front substrate; and an exhaust tube (21). A discharge space is formed by sealing the circumference of the front substrate with the circumference of the rear substrate. The exhaust tube is connected to the rear substrate for exhausting the discharge space and filling the discharge space with a discharge gas. The exhaust tube is formed of a lead-free glass, and the ratio of its thickness to its outer diameter is 0.2 or more.

This application is a U.S. National Phase application of PCT International Application PCT/JP2007/055534.

### TECHNICAL FIELD

The present invention relates to a plasma display panel (hereinafter abbreviated as PDP) which is a flat plate type display apparatus used in a large-size television receiver or a public display and a production method thereof. Particularly, the present invention relates to an evacuation pipe which introduces a discharge gas while being provided in a PDP to evacuate discharge spaces, and a method of producing a PDP including the evacuation pipe.

### BACKGROUND ART

A PDP can realize high definition and a large screen. Therefore, a 65-inch class television receiver, a large public display apparatus, and the like are being commercialized, and an over 100-inch product has also been realized.

Basically, a PDP includes a front plate and a rear plate. The front plate includes a glass substrate, display electrodes, a dielectric layer, and a protective layer. Sodium borosilicate glass produced by a float process is used as the glass substrate. The display electrodes include transparent electrodes and metal bus electrodes, which are formed in a stripe shape on a surface of the glass substrate. The dielectric layer is formed so as to cover the display electrodes, and acts as a capacitor. The protective layer is made of magnesium oxide (MgO), for example, and the protective layer is formed on the dielectric layer.

On the other hand, the rear plate includes a glass substrate, address electrodes (or data electrodes), an underlying dielectric layer, barrier ribs, and fluorescent layers. The glass substrate is provided with a small hole in order to evacuate air and introduce a discharge gas. The address electrodes are formed in a stripe shape on a surface of the glass substrate. The underlying dielectric layer covers the address electrodes. The barrier ribs are formed on the underlying dielectric layer. Each of the fluorescent layers which produces fluorescence of red, green, and blue colors respectively is formed between the barrier ribs.

The front plate and the rear plate are arranged such that electrode forming surface sides thereof faces each other, and peripheries thereof are sealed with a sealing material. An outlet is provided in the glass substrate of the rear plate, and the evacuation pipe (or tip pipe) for evacuating air and introducing a discharge gas is coupled to the outlet and sealed with a sealing material. The evacuation pipe is provided in order to evacuate discharge spaces partitioned by the barrier ribs through the small hole and introduce a discharge gas into the discharge spaces after evacuation. The space in the evacuation pipe is sealed in an airtight manner by locally heating and melting (tipping off) a proper portion of the evacuation pipe. In the completed PDP, when a video signal voltage is selectively applied to the display electrodes, discharge is generated in the discharge spaces, and an ultraviolet ray generated by the discharge excites the red, green, and blue fluorescent layers to emit light in the red, green, and blue colors. Thus, the PDP displays a color image.

The discharge spaces formed by the front plate, the rear plate, and the barrier ribs are evacuated, and the discharge gas is introduced into the discharge spaces. However, because each of the barrier rib has an extremely low profile, conductance is extremely small in evacuating air and introducing a gas. Therefore, it is desirable that an inner diameter of the evacuation pipe is enlarged as much as possible.

Generally, low-melting glass mainly containing a lead oxide is used as the dielectric layer and the sealing material. Furthermore, recent examples using a non-lead material, known as “lead-free material” or “leadless material”, containing no lead component, are disclosed for environmental concerns (for example, see Patent Documents 1, 2, and 3). Borosilicate glass containing lead is used in the conventional evacuation pipe because of a relatively low softening point and excellent sealing workability. However, there is a shift to use borosilicate glass containing no lead for environmental concerns.

A locally heating sealing method with a fixed gas burner or a current-carrying heater is adopted in sealing the evacuation pipe of the PDP in an airtight manner. Conventionally, the locally heating sealing method is widely used in producing lamp products such as an electric bulb, a fluorescent light, and a CRT. In the locally heating sealing method, a portion to be closed and sealed of the fixed evacuation pipe is locally heated, melted, and cut by the fixed gas burner or the current-carrying heater (for example, see Patent Document 4). As described above, in the case where the relatively low-melting glass pipe containing lead is used in the evacuation pipe of the PDP and the thick evacuation pipe is used, the glass pipe is generally sealed with electric heating sealing. In the case where the thin evacuation pipe is used, the glass pipe is generally sealed with the fixed gas burner.

FIGS. 5A to 5C are sectional views explaining an evacuation pipe sealing procedure of a conventional PDP. As shown in FIG. 5A, portion to be sealed 70 of evacuation pipe 71 is heated by flame 73 of gas burner 72 while the inside of the panel is evacuated through evacuation pipe 71. Portion to be sealed 70 is heated and softened during the evacuation, and portion to be sealed 70 is constricted and extended by a force in a direction of an arrow C caused by elastic portion 74 such as a spring provided in evacuation head 75 and a negative pressure in evacuation pipe 71. Then, as shown in FIG. 5B, glass walls softened at portion to be sealed 70 are melted, and the glass walls are fused at connection portion 76 by the action of additional surface tension. As shown in FIG. 5C, the force in the direction C further acts to cut evacuation pipe 71 at connection portion 76, and sealed portion 77 is formed to complete the sealing of evacuation pipe 71.

At that time, the negative pressure during the constriction and the surface tension during the fusion do not act in an axially symmetric manner with respect to a pipe axis of evacuation pipe 71. Therefore, deformation is partially generated to easily cause an uneven thickness of sealed portion 77. For example, as shown in FIG. 5D, recess 79 in which the partial thickness is extremely thin is sometimes generated, and thick and biased reservoir 78 is sometimes generated. As such, sealed portion 77 cut in a state where axial symmetry is disturbed may be formed. When sealed portion 77 is formed in the biased thickness, strain may remain. When the strain remains, leakage is generated or breakage occurs due to the generation of a crack in the thin portion of sealed portion 77 during the subsequent production process or handing of the product.

However, in the case where evacuation pipe 71 is made of relatively soft glass containing lead, the above problems are never generated irrespective of a pipe diameter, and reliability concerning the sealing does not become such a large problem. On the other hand, in the case where the sealing work is performed with gas burner 72 using the evacuation pipe made of the borosilicate glass containing no lead, the above-mentioned reservoir 78 or thin recess 79 is generated to disturb the good sealing. In addition, the crack is generated in sealed portion 77 and neighborhood of sealed portion 77 by generation of the strain, which causes decrease in reliability such as a shortened product lifetime.

Because the borosilicate glass containing no lead has a high softening point, the electric heating sealing by the current-carrying heater heating is frequently used when the local heating sealing is performed. The electric heating sealing has an advantage in that handling is easy during mass production and automation is easily achieved because a heating temperature can be relatively accurately controlled. However, when compared with the method in which gas burner 72 is used, the current-carrying heater which is the heating portion is enlarged. Additionally, because a time necessary for heating and cooling is lengthened, a production tact time is hardly shortened.

Patent Document 1: Unexamined Japanese Patent Publication No. 2002-053342

Patent Document 2: Unexamined Japanese Patent Publication No. 09-050769

Patent Document 3: Unexamined Japanese Patent Publication No. 2003-095697

Patent Document 4: Unexamined Japanese Patent Publication No. 2001-351528

### DISCLOSURE OF THE INVENTION

The present invention provides a PDP in which the decrease in reliability caused by sealing troubles such as a crack or leakage is not generated when an evacuation pipe made of lead-free hard glass having a small coefficient of thermal expansion is sealed with a gas burner.

The PDP according to the present invention includes a front plate and a rear plate which is arranged to face the front plate, and peripheries of the front plate and the rear plate are sealed and bonded to form a discharge space. In addition, an evacuation pipe to evacuate the discharge space and charge the discharge space with a discharge gas is provided. The evacuation pipe is made of lead-free glass, and a ratio of a thickness of the evacuation pipe to an outer diameter of the evacuation pipe is at least 0.2.

According to the above configuration, the glass thickness of the sealed portion of the evacuation pipe can evenly be formed, and the strong sealed portion can be formed with no residual stress caused by thermal strain in the sealed portion. Therefore, a highly reliable PDP without any leakage or a crack in the sealed portion can be realized. Because the evacuation pipe made of the borosilicate glass containing no lead is used, a totally lead-free PDP can be realized to eliminate the adverse influence on the environment. The enlargement can be prevented by sealing with the gas burner, and the time necessary to heat and cool the sealed portion can be shortened to decrease a man-hour of the sealing process.

### BRIEF DESCRIPTION OF THE DRAWINGS

FIG. 1 is a partially enlarged exploded perspective view showing a structure of a PDP in an embodiment of the present invention.

FIG. 2A is a plan view showing a state in which a front plate and a rear plate of the PDP in the embodiment of the present invention are sealed and bonded.

FIG. 2B is a sectional view taken on a line 2B-2B of FIG. 2A.

FIG. 3A is a sectional view showing a state in which an evacuation head is attached to an evacuation pipe of the PDP in the embodiment of the present invention.

FIG. 3B is a sectional view taken on a line 3B-3B of FIG. 3A.

FIG. 4A is a sectional view explaining a procedure sealing the evacuation pipe of the PDP in the embodiment of the present invention.

FIG. 4B is a sectional view explaining a procedure sealing the evacuation pipe of the PDP subsequent to FIG. 4A.

FIG. 4C is a sectional view explaining a procedure sealing the evacuation pipe of the PDP subsequent to FIG. 4B.

FIG. 5A is a sectional view explaining a procedure sealing an evacuation pipe of a conventional PDP.

FIG. 5B is a sectional view explaining a procedure sealing the evacuation pipe subsequent to FIG. 5A.

FIG. 5C is a sectional view explaining a procedure sealing the evacuation pipe subsequent to FIG. 5B.

FIG. 5D is an enlarged sectional view showing a sealed portion of the evacuation pipe shown in FIG. 5C.

### DETAILED DESCRIPTION OF THE INVENTION

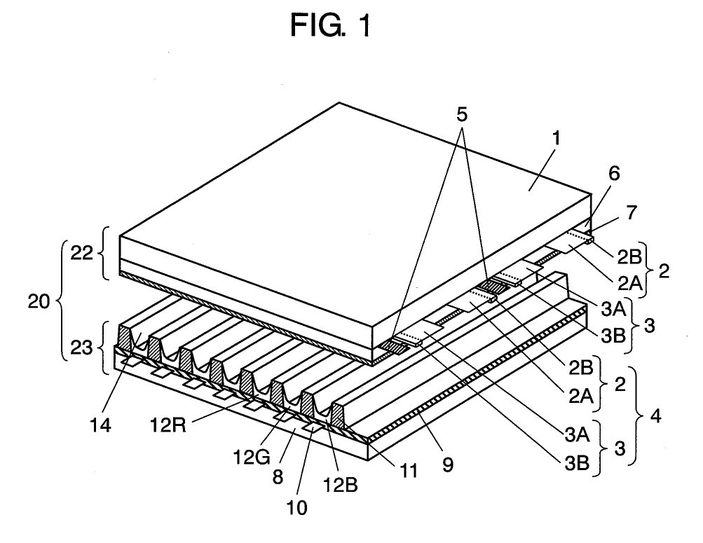

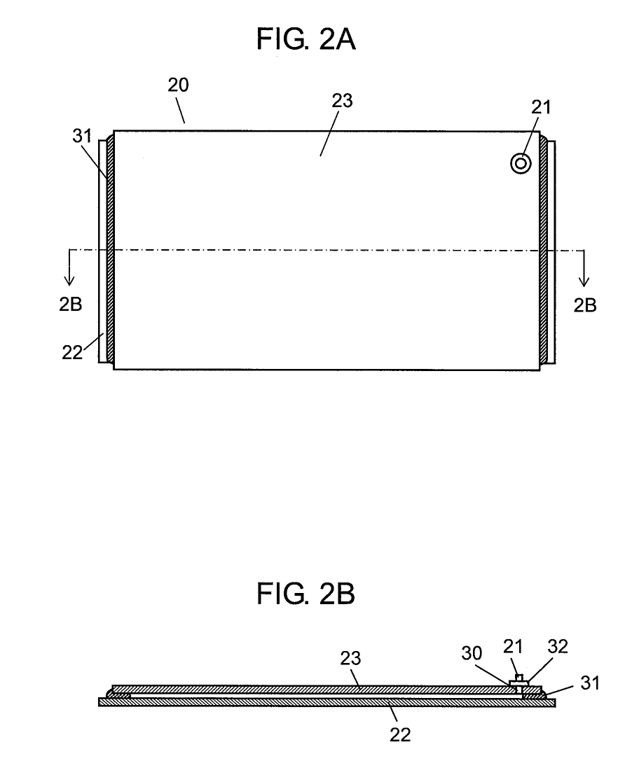

FIG. 1 is an exploded perspective view showing a partially enlarged plasma display panel (PDP) in an embodiment of the present invention, and FIGS. 2A and 2B are a plan view and a sectional view showing a state in which a front plate and a rear plate of the PDP shown in FIG. 1 are sealed and bonded.

PDP 20 includes front plate 22, rear plate 23, and evacuation pipe 21. Front plate 22 and rear plate 23 are arranged to face each other. Peripheries of front plate 22 and rear plate 23 are sealed and bonded, and discharge spaces 14 are formed by front plate 22, rear plate 23, and barrier ribs 11 formed on rear plate 23. Evacuation pipe 21 is used when discharge spaces 14 are evacuated to introduce the discharge gas into discharge spaces 14.

In front plate 22, pairs of scan electrode 2 for sequentially displaying and sustain electrode 3 for inputting a discharge sustaining signal are formed in a stripe shape on transparent front glass substrate 1. Display electrode 4 includes scan electrode 2 and sustain electrode 3, and plural pairs of scan electrode 2 and sustain electrode 3 are formed. Scan electrode 2 and sustain electrode 3 include transparent electrodes 2A and 3A made of an indium tin oxide and auxiliary electrodes (or metal bus electrodes) 2B and 3B made of conductive materials such as sliver respectively. Light shielding layer 5 which becomes a black matrix can be formed between the sets of sustain electrode 3 and scan electrode 2 to enhance contrast of a display surface, if needed. Dielectric layer 6 made of low-melting glass is formed so as to cover display electrodes 4. Protective layer 7 made of MgO is formed on dielectric layer 6. Front plate 22 is formed as described above.

Data electrodes (or address electrodes) 10 which input display data signals are formed in the stripe shape on rear glass substrate 8 which is arranged so as to face front glass substrate 1. Data electrode 10 is covered with underlying dielectric layer 9. Barrier ribs 11 are made on underlying dielectric layer 9 so as to be arranged in the stripe shape in parallel with data electrode 10. On side faces between barrier ribs 11 and on the surface of underlying dielectric layer 9, fluorescent layer 12R which emits the red light, fluorescent layer 12G which emits the green light, and fluorescent layer 12B which emits the blue light are formed, so as to constitute rear plate 23. Fluorescent layers 12R, 12G, and 12B are separately and sequentially formed in discharge spaces (or discharge cells) 14 partitioned by barrier ribs 11. Rear plate 23 is formed as described above.

Front plate 22 and rear plate 23 are arranged to face each other across fine discharge spaces 14 such that display electrodes 4 and data electrodes 10 are orthogonal to each other. After the peripheries of front plate 22 and rear plate 23 are sealed and vacuum evacuated with a predetermined pressure, discharge spaces 14 are filled at a predetermined pressure with a mixed rare gas, such as neon (Ne) and xenon (Xe), which is the discharge gas. Discharge is generated to emit an ultraviolet ray in the sealed rare gas by applying a voltage pulse of a predetermined signal to sustain electrodes 3, scan electrodes 2, and data electrodes 10. Fluorescent layers 12B, 12G, and 12R are excited by the ultraviolet ray to emit visible light. Thus, PDP 20 displays information.

Next, production method for the PDP will be briefly described. Transparent electrodes 2A and 3A which constitute scan electrode 2 and sustain electrode 3 respectively are formed on front glass substrate 1. Then, auxiliary electrodes 2B and 3B and light shielding layer 5 are formed. Next, dielectric layer 6 having a predetermined thickness is formed so as to cover transparent electrodes 2A and 3A, auxiliary electrodes 2B and 3B, and light shielding layer 5 by a screen printing method or the like. Protective layer 7 having a predetermined thickness is formed on dielectric layer 6 by a film formation process such as a vacuum evaporation method, so as to complete front plate 22.

On the other hand, data electrodes 10 are formed in the stripe shape on rear glass substrate 8 by the screen printing method, a photolithography method, or the like. Underlying dielectric layer 9 is formed by the screen printing method or the like so as to cover data electrodes 10. Then, barrier ribs 11 are formed, e.g., in the stripe shape by the screen printing method, die coating method, photolithography method, or the like. Fluorescent layers 12R, 12G, and 12B are formed in a groove between adjacent barrier ribs 11, so as to complete rear plate 23.

Then, as shown in FIGS. 2A and 2B, the peripheries of front plate 22 and rear plate 23 are sealed and bonded by sealing material 31. At this time, front plate 22 and rear plate 23 are arranged to face each other such that display electrodes 4 and address electrodes 10 are orthogonal to each other. Rear plate 23E is previously provided with evacuation hole 30 at a predetermined position therein. Evacuation pipe 21 is sealed and bonded with sealing material 32 so as to cover evacuation hole 30. Sealing material 32 is applied in the periphery of the expanded end portion of evacuation pipe 21. Sealing materials 31 and 32 are formed by low-melting glass frit, for example.

Then, discharge spaces 14 are evacuated to high vacuum (for example, 1.1×10⁻⁴ Pa) through evacuation pipe 21. Then, discharge spaces 14 are charged with the discharge gas including neon, xenon, and the like through evacuation pipe 21 at a predetermined pressure (for example, pressure of 5.3×10⁴ Pa to 8.0×10⁴ Pa in the case of Ne—Xe mixed gas). The evacuation pipe 21 is sealed and cut, thereafter. Thus, PDP 20 is completed.

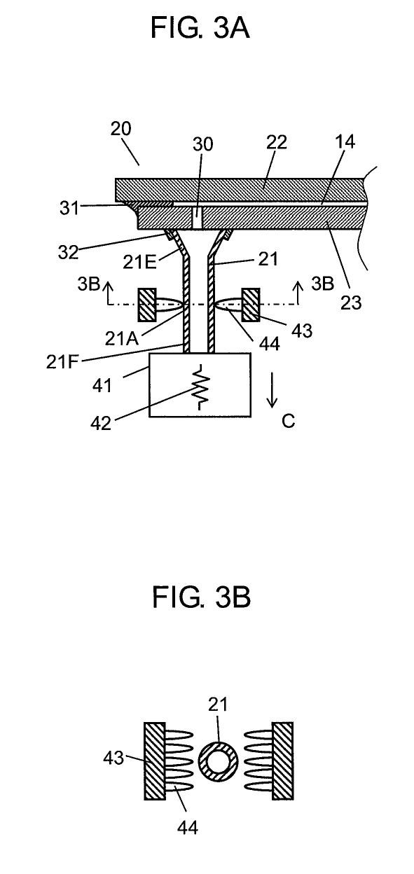

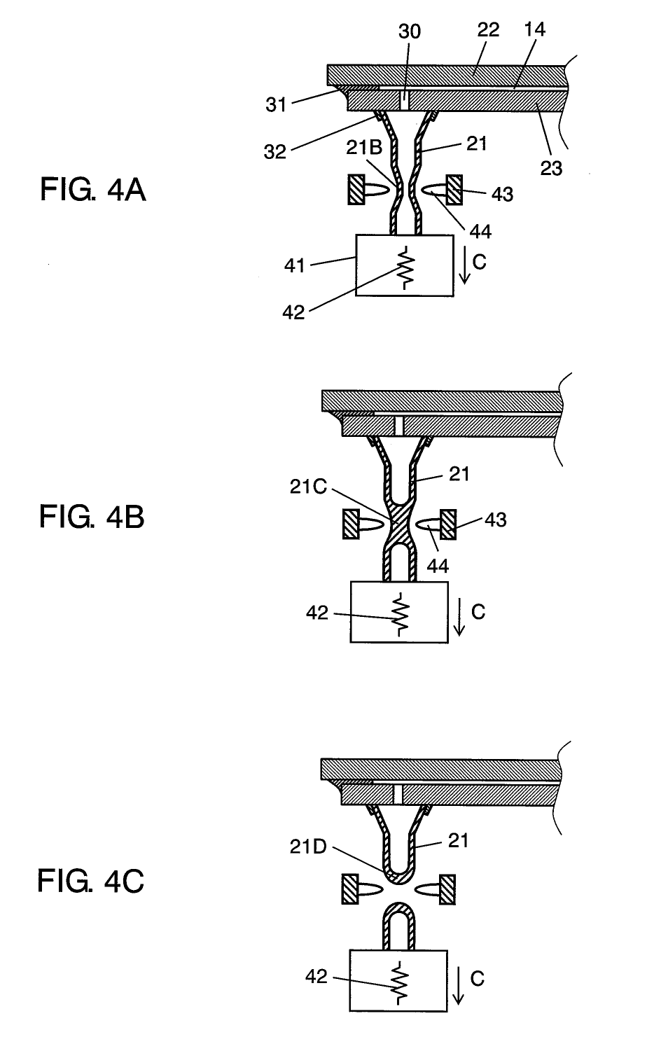

Procedures of sealing evacuation pipe 21 will be described with reference to FIGS. 3A to 4C. FIG. 3A is a sectional view showing a state in which an evacuation head is attached to the evacuation pipe of the PDP in the embodiment of the present invention, FIG. 3B is a sectional view taken on a line 3B-3B of FIG. 3A, and FIGS. 4A to 4C are sectional views explaining procedures sealing the evacuation pipe of the PDP in the embodiment of the present invention.

The locally heating sealing method in which the fixed gas burner or the current-carrying heater is used is adopted in sealing evacuation pipe 21. In the locally heating sealing method, as shown in FIG. 3A, portion to be sealed 21A of fixed evacuation pipe 21 is sequentially heated, melted, and cut. The electric heating sealing in which the current-carrying heater is used has the advantages in that handling is easy during mass production and automation is easily achieved because the heating temperature can be relatively accurately controlled. However, compared with the method in which the fixed gas burner is used, the current-carrying heater which is the heating portion is enlarged, and the time necessary for heating and cooling is lengthened. Therefore, the production tact time is hardly shortened. Accordingly, evacuation pipe 21 is sealed with fixed gas burner 43 in the embodiment of the present invention.

As shown in FIGS. 3A and 3B, evacuation pipe 21 is arranged so as to cover evacuation hole 30 made at a predetermined position in rear plate 23. End portion 21E of evacuation pipe 21 has a enlarged funnel shape, and another end portion 21F is formed in a straight pipe shape having an outer diameter of about 5.0 mm. Evacuation pipe 21 is made of the borosilicate glass which contains no lead component and has a relatively small thermal conductivity. It is not true that the borosilicate glass does not contain lead at all, and an analysis shows that the borosilicate glass contains a trace amount of lead at a PPM level. However, in the definition of the EC-RoHS directive in Europe, it can be assumed that the borosilicate glass contains no lead when the content is not more than 1000 PPM. Therefore, expressions such as “contains no lead”, “non-lead”, and “lead-free” are used for glass having such compositions in the embodiment of the present invention.

Sealed and bonded PDP 20 is arranged on a panel fixing base (not shown) such that straight-pipe shaped end portion 21F of evacuation pipe 21 located on the side attached to an evacuation device (not shown) is orientated downward. Evacuation head 41 of the evacuation device is attached to end portion 21F, the inside of PDP 20 is evacuated in a furnace at a predetermined temperature, and the discharge gas is charged. Then, fixed gas burner 43 is arranged to heat an outer periphery of portion to be sealed 21A. Evacuation head 41 has applying portion 42 including a spring or the like such that force is applied to evacuation pipe 21 downward, i.e., toward the direction shown by the arrow C in FIG. 3A. It is preferable that gas burner 43 has a configuration in which plural flames 44 are horizontally formed in a plane perpendicular to evacuation pipe 21 as shown in FIG. 3B.

As shown in FIG. 4A, evacuation pipe 21 is softened when the outer periphery of portion to be sealed 21A of evacuation pipe 21 is heated to a predetermined temperature by flame 44. Then, portion to be sealed 21A is vertically extended because of the decreased pressure in evacuation pipe 21 communicated with discharge spaces 14 shown in FIG. 1 and the force of applying portion 42, which forms shrinking portion 21B. When shrinking portion 21B is continuously heated by flame 44, the inner surfaces of evacuation pipe 21 come into contact with each other to form melting connection portion 21C as shown in FIG. 4B, and the glass becomes an evenly melted state. At this time, the fire of gas burner 43 is strengthened and the force of applying portion 42 in the direction C is decreased, and glass viscosity is thus decreased in melting connection portion 21C. Sequentially, the force of applying portion 42 is increased, so that melting connection portion 21C is extended and thinned, and finally cut. As a result, as shown in FIG. 4C, sealed portion 21D is formed which has a curved end portion and a substantially even glass thickness, and sealing of evacuation pipe 21 is thus completed.

Formation of sealed portion 21D which has the curved end portion and the substantially even glass thickness as shown in FIG. 4C is attributed to the following reason. That is, the thickness of evacuation pipe 21 is not extremely thin, and melting connection portion 21C has a sufficient length. The glass of sealed portion 21D extended and thinned during cutting becomes immediately massed together by the heat of flame 44 of gas burner 43 whose fire is strengthened. It is thought that a volume of the glass melted at the low viscosity and the surface tension of the melted portion contribute to the formation of such sealed portion 21D. In other words, the thickness of evacuation pipe 21 is not extremely thin, and melting connection portion 21C has a sufficient length, so that the melted glass of sealed portion 21D has a proper volume. Therefore, the melted glass of sealed portion 21D is not sucked irrespective of the negative pressure in evacuation pipe 21. As with the sealing with the electric-current heater, it is thought that the cooling process is controlled by a sufficient heat capacity of sealed portion 21D. Therefore, it is assumed that sealed portion 21D which has the curved end portion and the substantially even glass thickness is formed as shown in FIG. 4C. Although longer time is required in this method compared with the conventional sealing method in which the gas burner is used, the fire of gas burner 43 and the force of applying portion 42 are easily controlled. Therefore, the longer time does not become a large problem.

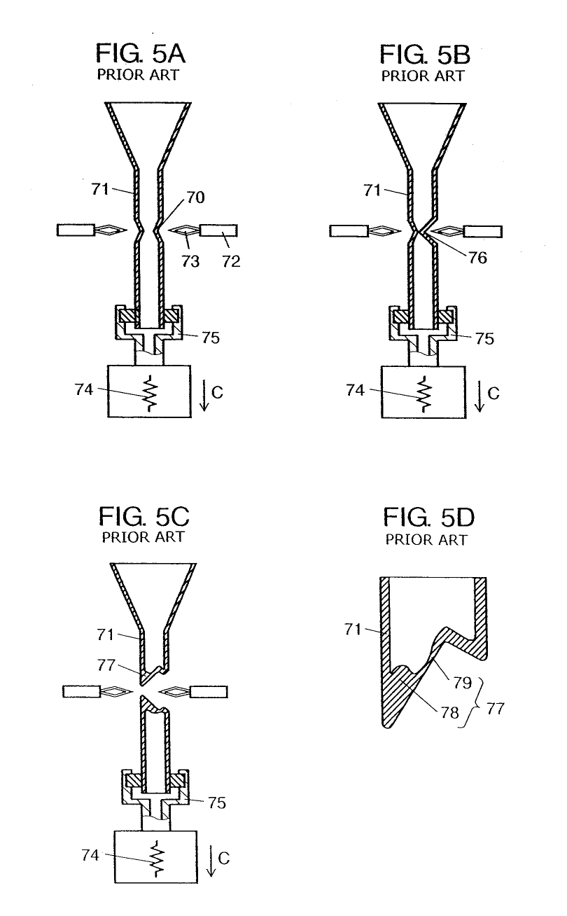

However, even if evacuation pipe 21 made of the borosilicate glass containing no lead is sealed by the above-described method, not all sealed portions 21D are formed in the shape shown in FIG. 4C. When some samples are actually observed, sometimes sealed portion 21D is formed as shown in FIG. 4C, and sometimes sealed portion 77 is formed as shown in FIG. 5D. In sealed portion 21D shown in FIG. 4C, the glass has a substantially even thickness and a curved shape. In sealed portion 77 shown in FIG. 5D, the glass has reservoir 78 or thin recess 79.

When these PDPs 20 are subjected to a heating and cooling repetition test, there is generated no problem in PDPs 20 in which sealed portion 21D is formed, whereas the leakage defect or breakage due to the crack is frequently generated in PDPs 20 in which sealed portion 77 is formed. This shows that the little strain remains in sealed portion 21D while the strain caused by the residual stress still remains in sealed portion 77.

A close investigation of measurement data between the outer diameter and the thickness of evacuation pipe 21 of PDP 20 in which evacuation pipe 21 is sealed by the above method shows that acceptable products are distinguished from defective products depending on the thickness of evacuation pipe 21. The thicknesses of evacuation pipes 21 having nominal outer diameters of 5.0 mm are distributed in a range of 0.9 mm to 1.4 mm. In the case where the thickness is at least 1.0 mm (inner diameter is at most 3.0 mm), sealed portion 21D is formed, and there is no defect in the heating and cooling repetition test. However, in the case where the thickness is less than 1.0 mm (inner diameter is more than 3.0 mm), sometimes sealed portion 77 shown in FIG. 5D is formed. In such cases, some products include the defect such as the leakage in the heating and cooling repetition test.

Therefore, the evacuation pipes are prepared from eight types of lead-free borosilicate glass which have the nominal outer diameter of 5.0 mm and the thicknesses of 0.8 mm, 0.9 mm, 1.0 mm, 1.1 mm, 1.2 mm, 1.3 mm, 1.4 mm, and 1.5 mm, and the PDP samples in which the evacuation pipes are sealed by the above procedure are produced. An appearance inspection of the sealed portion and the heating and cooling repetition test are performed to these samples. In the sealed portions in which the six types of evacuation pipes having the thicknesses of 1.0 mm or more are used, the sealing was performed in a shape that the curved glass had the substantially even thickness as shown in FIG. 4C, and there occurs no problem in the heating and cooling repetition test. On the other hand, in PDP in which the remaining two types of evacuation pipes having the thicknesses of 0.8 mm and 0.9 mm which are less than 1.0 mm are used, as evacuation pipe is thinned, the number of PDPs having sealed portion 77 of the uneven thickness shown in FIG. 5D is increased. Furthermore, as the thickness is decreased, the generation of the defect such as leakage and a crack tends to be remarkably increased.

As the result mentioned above, it is preferable that the thickness of the evacuation pipe be at least 1.0 mm, when the sealing is performed with the gas burner by the above method using the evacuation pipe, which has the nominal outer diameter of 5.0 mm and is made of the borosilicate glass containing no lead. When the evacuation pipe having such dimensions is used, the sealed portion is formed in the curved shape having the even thickness, and the defect such as the leakage and the crack is not generated in the sealed portion.

However, in the evacuation pipe having the nominal outer diameter of 5.0 mm, when the thickness exceeds 1.5 mm, the inner diameter of the evacuation pipe becomes less than 2.0 mm which is the diameter of evacuation hole 30. In such dimensional configuration, the evacuation conductance is decreased to lengthen the evacuation time. Therefore, the thickness of evacuation pipe 21 is preferably set such that the inner diameter of evacuation pipe 21 is not smaller than the diameter of evacuation hole 30.

Then, the case in which sealing is performed by the above method using the evacuation pipe which has the nominal outer diameter different from 5.0 mm and is made of the lead-free borosilicate glass will be described.

The evacuation pipes having the four types of nominal outer diameters of 3.5 mm, 4.0 mm, 6.0 mm, and 7.0 mm are prepared. The samples in which these evacuation pipes are sealed by the above procedure are produced, and the appearance inspection of the sealed portion and the heating and cooling repetition test are performed. As described above, in the case of the evacuation pipe having the nominal outer diameter of 5.0 mm, the sealed portion is formed in the curved shape having substantially even thickness as shown in FIG. 4C when the evacuation pipe having the thickness of 1.0 mm or more is used. The defect such as the leakage and the crack is not generated through the heating and cooling repetition test in the sealed portion. Even in the four types of evacuation pipes having the nominal outer diameters different from 5.0 mm, it is found that the glass pipes have the thickness as the boundary.

That is, according to the thickness measurement values of the evacuation pipes, the thickness boundary values are 0.7 mm, 0.8 mm, 1.2 mm and 1.4 mm in the evacuation pipes having the nominal outer diameters of 3.5 mm, 4.0 mm, 6.0 mm, and 7.0 mm, respectively. As is clear from the results, a ratio of the thickness to the outer diameter of the evacuation pipe is 0.2, and the ratio is kept constant irrespective of the nominal outer diameter. Accordingly, it is necessary that the ratio of the thickness of the evacuation pipe to the outer diameter of the evacuation pipe be at least 0.2 irrespective of the numerical values of the thickness and outer diameter of the evacuation pipe. In consideration of the evacuation conductance, it is preferable that the thickness of the evacuation pipe be set such that the inner diameter of the evacuation pipe is not lower than the diameter of the evacuation hole to which the evacuation pipe is connected.

As described above, the ratio of the thickness to the outer diameter of the evacuation pipe made of the lead-free borosilicate glass is set to 0.2 in the PDP according to the embodiment of the present invention. Thus, because the thickness is set to a relatively thick value, the glass thickness of the sealed portion can evenly be formed even if the sealing is performed with the fixed gas burner. As a result, the strong sealed portion having no residual stress caused by the thermal strain can be formed to realize a high-reliability PDP in which leakage or a crack is not generated in the sealed portion. Because of the use of the evacuation pipe made of the lead-free borosilicate glass, a totally lead free PDP can be realized, and the load on the environment can be eliminated. Additionally, because the sealing can be performed with the gas burner, the apparatus is not enlarged unlike the electric heating sealing, and the time necessary to heat and cool the sealed portion can be shortened to decrease the sealing man-hour. As a result, manufacturing cost of the PDP can be reduced to provide the PDP at a moderate price.

As described above, the evacuation pipe made of the lead-free, hard borosilicate glass having the small coefficient of thermal expansion is sealed with the gas burner in the PDP and the production method thereof according to the present invention. Even in such cases, there is no decrease in reliability such as the crack and the leakage which is associated with the trouble with the sealed portion. Additionally, the production tact time is shortened to decrease the man-hour, which allows the high-quality PDP to be produced at a moderate price. As long as the borosilicate glass contains no lead is used, the same effect is obtained when the borosilicate glass is used in the evacuation pipe 21. Particularly, among various kinds of the lead-free glass, a temperature-viscosity curve of the borosilicate glass is close to that of the glass material containing lead. Therefore, conditions of the gas burner and the like can be set similar to those of the glass material containing lead.

### INDUSTRIAL APPLICABILITY

In the present invention, the ratio of the thickness to the outer diameter of the evacuation pipe made of the lead-free glass is set to 0.2, namely the thickness is set to a relatively thick value. Therefore, even if the sealing is performed with the fixed gas burner, the glass thickness of the sealed portion can evenly be formed, and the defect such as the leakage and the crack is not generated in the sealed portion. Thus, the configuration and the production method for producing the high-reliability PDP which adapts to the environment are suitable to the large-screen display device and the like.

1. A plasma display panel comprising:
a front plate;
a rear plate arranged to face the front plate, a periphery of the front plate and a periphery of the rear plate being sealed and bonded to form a discharge space; and
an evacuation pipe connected to the rear plate, the evacuation pipe being provided in order to evacuate the discharge space and charge the discharge space with a discharge gas,
wherein the evacuation pipe is made of lead-free glass, and a ratio of a thickness of the evacuation pipe to an outer diameter of the evacuation pipe is at least 0.2.

2. The plasma display panel according to claim 1, wherein the evacuation pipe is made of lead-free borosilicate glass.

3. A producing method of a plasma display panel, the method comprising:
evacuating a discharge space through an evacuation pipe, the evacuation pipe being connected to a rear plate which is arranged to face a front plate, a periphery of the front plate and a periphery of the rear plate being sealed and bonded to form the discharge space;
charging the discharge space with a discharge gas; and
sealing the evacuation pipe with a gas burner,
wherein a ratio of a thickness of the evacuation pipe to an outer diameter of the evacuation pipe is at least 0.2, and the evacuation pipe is made of lead-free glass.

4. The producing method of a plasma display panel according to claim 3, wherein the evacuation pipe is made of lead-free borosilicate glass.
